(19) United States
(12) Patent Application Publication
(10) Pub. No.: US 2024/0151298 A1
(43) Pub. Date: May 9, 2024

(54) TORQUE CONVERTER WITH MULTI-PLATE CLUTCH ASSEMBLY

(71) Applicant: Schaeffler Technologies AG & Co. KG, Herzogenaurach (DE)

(72) Inventors: Alfredo Perez Mitre Jimenez, Wooster, OH (US); Juan Bernardo Sosa, Huejotzingo (MX); Omar Yair Guerra, Puebla (MX); Jaqueline Del Angel, Puebla (MX)

(73) Assignee: Schaeffler Technologies AG & Co. KG, Herzogenaurach (DE)

(21) Appl. No.: 17/980,452

(22) Filed: Nov. 3, 2022

(51) Int. Cl. F16H 45/02

(52) U.S. Cl. CPC F16H 45/02; F16H 2045/0284

(57) ABSTRACT

A torque converter includes a front cover arranged to receive a torque and a lock-up clutch. The lock-up clutch includes a leaf spring, a piston, a first clutch plate, a second clutch plate, and an intermediate clutch plate. The leaf spring includes a base non-rotatably connected to the front cover and two legs extending from the base. The piston is non-rotatably connected to one of the legs. The first clutch plate and the second clutch plate are connected to each other. The first and second clutch plates each being disposed between the piston and front cover. The intermediate clutch plate is disposed between the first and second clutch plates and is non-rotatably connected to the other of the legs.

### TECHNICAL FIELD

The present disclosure relates to a torque converter for a vehicle. In particular, the disclosure is related to a multi-plate clutch assembly of a torque converter.

### BACKGROUND

Many vehicles include a launch device between the engine and the transmission. A torque converter is a type of launch device commonly used in vehicles having an automatic transmission. A typical torque converter includes an impeller fixed to the crankshaft of the engine and a turbine fixed to a turbine shaft, which is the input to the transmission. To improve fuel economy, most torque converters include a bypass or lock-up clutch that mechanically couples the turbine shaft to a case of the torque converter to bypass the fluid coupling. Due to limited spacing within a torque converter envelope, it is desirable to have alternative designs and configurations to fit all the necessary components within the torque converter while still meeting durability and performance requirements.

### SUMMARY

Embodiments of this disclosure provide a torque converter including a front cover arranged to receive a torque and a lock-up clutch. The lock-up clutch includes a leaf spring, a piston, a first clutch plate, a second clutch plate, and an intermediate clutch plate. The leaf spring includes a base non-rotatably connected to the front cover and two legs extending from the base. The piston is non-rotatably connected to one of the legs. The first clutch plate and the second clutch plate are connected to each other. The first and second clutch plates each being disposed between the piston and front cover. The intermediate clutch plate is disposed between the first and second clutch plates and is non-rotatably connected to the other of the legs.

In embodiments, the intermediate clutch plate may be connected to the other of the legs at a radial inner end thereof. In embodiments, the intermediate clutch plate may be connected to the other of the legs radially inside of the first and second clutch plates. In embodiments, the piston may be connected to the one of the legs radially inside of the first and second clutch plates. The piston may be connected to the one of the legs radially inside of the intermediate clutch plate.

In embodiments, the first clutch plate may be connected to the second clutch plate radially outside of the intermediate clutch. In embodiments, the first clutch plate may be connected to the second clutch plate radially outside of the piston. In embodiments, the base may be connected to the front cover radially inside of the intermediate clutch plate. In embodiments, the intermediate clutch plate may be supported by the leaf spring.

In embodiments, the legs may be radially spaced from each other. In embodiments, the legs may extend circumferentially from the base. The legs may be arranged on a same circumferential side of the base. In embodiments, the one leg may be disposed axially between the piston and the front cover, and the other leg may be disposed axially between the intermediate clutch plate and the front cover.

Embodiments of this disclosure further provide a lock-up clutch for a torque converter. The lock-up clutch includes a leaf spring, a piston, a first clutch plate, a second clutch plate, and an intermediate clutch plate. The leaf spring includes a base and two legs extending from the base. The piston is non-rotatably connected to one of the legs. The first clutch plate and the second clutch plate are connected to each other. The intermediate clutch plate is disposed between the first and second clutch plates and is non-rotatably connected to the other of the legs.

In embodiments, the intermediate clutch plate may be connected to the other of the legs at a radial inner end thereof. In embodiments, the intermediate clutch plate may be connected to the other of the legs radially inside of the first and second clutch plates. In embodiments, the piston may be connected to the one of the legs radially inside of the first and second clutch plates. The piston may be connected to the one of the legs radially inside of the intermediate clutch plate. In embodiments, the intermediate clutch plate may be supported by the leaf spring.

In embodiments, the legs may be radially offset relative to each other. In embodiments, the legs may extend circumferentially from the base. The legs may be arranged on a same circumferential side of the base.

### BRIEF DESCRIPTION OF THE DRAWINGS

FIG. 1 is a cross-sectional view of a torque converter according to the present disclosure.

FIG. 2 is perspective view of a leaf spring according to the present disclosure.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In some torque converter arrangements, it may be challenging and difficult to connect and center a second outer clutch plate of a multi-plate lock-up clutch to the torque converter due to limited packaging and space constraints. Additionally, because of the multi-plate design, it is required that all clutch plates have relative motion where required to generate the required friction. Embodiments described herein provide a multi-plate clutch assembly with a flexible, intermediate clutch plate and a piston each attached directly to one respective leg of a leaf spring package. Embodiments according to the present disclosure provide several advantages including providing a multi-plate clutch assembly for torque converters with space constraints as described above.

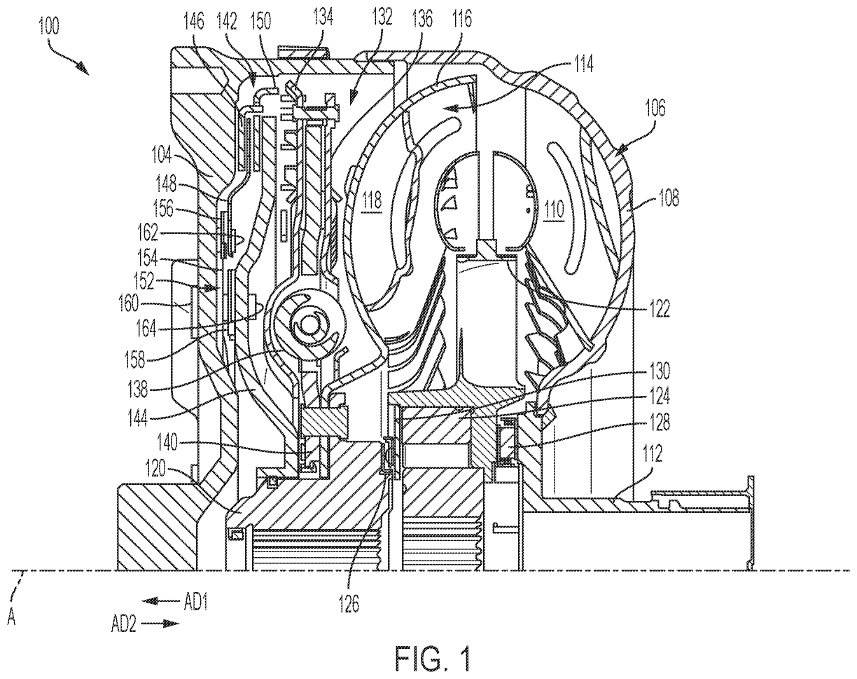

Referring to FIG. 1, a portion of a torque converter 100 is illustrated according to one embodiment of the present disclosure. At least some portions of the torque converter 100 are rotatable about a central axis A. While only a portion of the torque converter 100 above the central axis A is shown in FIG. 1, it should be understood that the torque converter 100 can appear substantially similar below the central axis A with many components extending about the central axis A. Words such as “axial,” “radial,” “circumferential,” “outward,” etc. as used herein are intended to be with respect to the central axis A.

Torque converter 100 includes: front cover 104 arranged to receive torque; impeller 106; turbine 114; and a lock-up clutch 142. Impeller 106 includes: impeller shell 108 non-rotatably connected to front cover 104 such that impeller 106 rotates as front cover 104 rotates, at least one impeller blade 110 attached to an inner surface of impeller shell 108, and impeller hub 112 attached to a radially inner end of impeller shell 108. Turbine 114 includes turbine shell 116 and at least one turbine blade 118 attached thereto. Turbine shell 116 may be connected to output hub 120 for torque transmission therebetween. By “non-rotatably connected” components, we mean that: the components are connected so that whenever one of the components rotate, all the components rotate; and relative rotation between the components is not possible. Radial and/or axial movement of non-rotatably connected components with respect to each other is possible, but not required.

Torque converter 100 may include: stator 122 disposed axially between impeller 106 and turbine 114 to redirect fluid flowing from turbine blade 118 before fluid reaches impeller 106 to increase an efficiency of torque converter 100. For example, impeller blade 110 when rotated about central axis A, pushes the fluid outwardly. The fluid pushes against turbine 114 of torque converter 100, causing turbine 114 to revolve about central axis A. Stator 122 functions to return the fluid from turbine 114 back to impeller 106 with minimal or no power loss. Drive power is transmitted from turbine 114 to an input shaft of the transmission (not shown). Torque converter 100 may further include: one-way clutch 124 disposed within stator 122, thrust bearing 126 disposed axially between stator 122 and turbine shell 116 and thrust bearing 128 disposed axially between stator 122 and impeller shell 108, and side plate 130 configured to retain the one-way clutch 124 within the stator 122.

Torque converter 100 also includes damper assembly 132 for hydraulically transferring torque through torque converter 100. Damper assembly 132 is positioned axially between front cover 104 and turbine 114 and may be configured to transfer torque from front cover 104 to the output hub 120. Damper assembly 132 may include input cover plate 134, input cover plate 136, springs 138, and output flange 140. Input cover plate 134 may support springs 138 on one axial side. Input cover plate 136 may support springs on another, opposite axial side. Output flange 140 may be connected to output hub 120 for torque transmission therebetween. Output flange 140 may be connected to turbine shell 116, e.g., via a connector such as a rivet.

Power from a vehicle engine (not shown) can be transmitted to a transmission (not shown) via fluid, and via the torque converter. In particular, the power may first be transmitted to front cover 104 of torque converter 100. Lock-up clutch 142 is configured to selectively transfer torque from front cover 104 to the damper assembly 132. Lock-up clutch 142 includes piston 144, clutch plate 146, clutch plate 148, clutch plate 150, and a leaf spring 152.

Clutch plate 146 and clutch plate 150 may be connected to one another (e.g., via a tabbed connection) and act as outer clutch plates, with clutch plate 150 directly connected to an input of damper assembly 132. For example, clutch plate 150 may be drivingly connected to input cover plate 134 to transfer torque thereto, e.g., via a tabbed connection. Clutch plate 148 may be disposed axially between clutch plates 146, 150. Clutch plate 148 may be supported by the leaf spring 152. Clutch plate 148 may be designed as a flexible clutch plate and referred to herein as flexible clutch plate 148. During the overbend process, clutch plate 148 is configured to move together and relative to piston 144, returning back to its working position after the riveting.

Piston 144 may be sealed to output hub 120 at an inner diameter thereof and configured to axially displace toward and away from front cover 104 to engage (close) and disengage (open) lock-up clutch 142. Clutch plate 146 may be disposed, at least partially, between front cover 104 and flexible clutch plate 148, and clutch plate 150 may be disposed between flexible clutch plate 148 and piston 144. Friction paper or rings may further be attached to front cover 104, clutch plate 146, flexible clutch plate 148, clutch plate 150 and/or piston 144. For example, friction materials (facings) may be attached to outer clutch plates 146, 150 and flexible clutch plate 148 may act as friction surface for the friction facings.

For the clutch release and apply function of lock-up clutch 142, clutch plate 148 is designed as a flexible clutch plate. That is, clutch plate 148 is bendable relative to piston 144, e.g., during operation of lock-up clutch 142. For example, clutch plate 148 may be formed from material such as 1074/1075 steel. The clutch plate 148 is designed to allow axial conformity between piston 144 and clutch plate 148. For example, holes may be provided in clutch plate 148, e.g., in various geometries, to reduce rigidity of the clutch plate 148 and thereby achieve a desired flexibility relative to piston 144. Additionally, or alternatively, a taper may be added to clutch plate 148, which can reduce or avoid undesirable drag torque during the release process of lock-up clutch 142.

The leaf spring 152 includes a base 154 and two legs 156, 158 extending from the base 154. The base 154 is disposed axially between the front cover 104 and the clutch plate 148. The base 154 is non-rotatably connected to the front cover 104, e.g., via a connector 160 such as a rivet. The connector 160 may be disposed radially inside at least one of the legs 156, 158. The connector 160 may be disposed radially inside of the clutch plate 148. The connector 160 may be axially spaced from the piston 144.

Each leg 156, 158 is connected to one of the piston 144 or the clutch plate 148. For example, the leg 156 may be non-rotatably connected to the clutch plate 148, e.g., via a connector 162 such as a rivet, at a radially inner end thereof, and the leg 158 may be non-rotatably connected to the piston 144, e.g., via a connector 164 such as a rivet. In such an example, the leg 156 may be disposed axially between the front cover 104 and the clutch plate 148, and the leg 158 may be disposed axially between the front cover 104 and the piston 144. The connector 164 may be disposed radially inside of the clutch plate 148. The connector 164 may be axially spaced from the front cover 104. The connector 162 may be axially spaced from the piston 144 and/or the front cover 104.

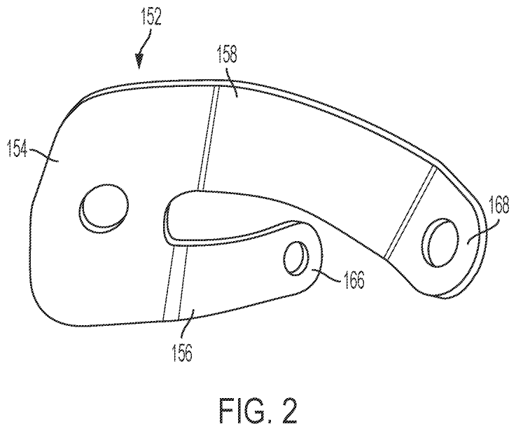

Referring to FIG. 2, the legs 156, 158 may extend transverse to the base 154. The legs 156, 158 may extend from a same circumferential side of the base 154. That is, the legs 156, 158 may extend from the base 154 in a same circumferential direction. The two legs 156, 158 are radially spaced from each other. For example, one of the legs 156 may be arranged at a radially outer side of the base 154, and the other of the legs 158 may be arranged at a radially inner side of the base 154. The legs 156, 158 may have a same or different radial thickness.

Each leg 156, 158 extends from the base 154 to an end 166, 168. The ends 166, 168 of the legs 156, 158 may be circumferentially offset relative to each other. The legs 156, 158 may be connected to the clutch plate 148 or the piston 144 at respective ends 166, 168 of the legs 156, 158. Each end 166, 168 may be disposed axially between the front cover 104 and at least one of the clutch plate 148 or the piston 144.

The leg 158 allows axial displacement of the piston 144 in a first axial direction AD1 and a second axial direction AD2 for selective engagement of lock-up clutch 142. The leg 156 allows axial displacement of the clutch plate 148 relative to the piston 144. Connecting the clutch plate 148 and the piston 144 to separate legs 156, 158 of the leaf spring 152 allows for relative motion between the piston 144 and the clutch plate 148, which assists in centering the clutch plate 148 between the outer clutch plates 146, 150 and generating friction between the clutch plate 148 and the outer clutch plates 146, 150.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### LIST OF REFERENCE NUMBERS

100 torque converter
104 front cover
106 impeller
108 impeller shell
110 impeller blade
112 impeller hub
114 turbine
116 turbine shell
118 turbine blade
120 output hub
122 stator
124 one-way clutch
126 thrust bearing
128 thrust bearing
130 side plate
132 damper assembly
134 input cover plate
136 input cover plate
138 springs
140 output flange
142 lock-up clutch
144 piston
146 clutch plate
148 clutch plate
150 clutch plate
152 leaf spring
154 body
156 leg
158 leg
160 connector
162 connector
164 connector
166 end
168 end
A central axis

What is claimed is:

1. A torque converter, comprising:
a front cover arranged to receive a torque; and
a lock-up clutch including:
a leaf spring including a base non-rotatably connected to the front cover and two legs extending from the base;
a piston non-rotatably connected to one of the legs;
a first clutch plate and a second clutch connected to each other, the first and second clutch plates each being disposed between the piston and front cover; and
an intermediate clutch plate disposed between the first and second clutch plates and non-rotatably connected to the other of the legs.

2. The torque converter according to claim 1, wherein the intermediate clutch plate is connected to the other of the legs at a radial inner end thereof.

3. The torque converter according to claim 1, wherein the intermediate clutch plate is connected to the other of the legs radially inside of the first and second clutch plates.

4. The torque converter according to claim 1, wherein the piston is connected to the one of the legs radially inside of the first and second clutch plates.

5. The torque converter according to claim 4, wherein the piston is connected to the one of the legs radially inside of the intermediate clutch plate.

6. The torque converter according to claim 1, wherein the first clutch plate is connected to the second clutch plate radially outside of the intermediate clutch.

7. The torque converter according to claim 1, wherein the first clutch plate is connected to the second clutch plate radially outside of the piston.

8. The torque converter according to claim 1, wherein the base is connected to the front cover radially inside of the intermediate clutch plate.

9. The torque converter according to claim 1, wherein the intermediate clutch plate is supported by the leaf spring.

10. The torque converter according to claim 1, wherein the legs are radially spaced from each other.

11. The torque converter according to claim 1, wherein the legs extend circumferentially from the base, the legs being arranged on a same circumferential side of the base.

12. The torque converter according to claim 1, wherein the one leg is disposed axially between the piston and the front cover, and the other leg is disposed axially between the intermediate clutch plate and the front cover.

13. A lock-up clutch for a torque converter, comprising:
a leaf spring including a base and two legs extending from the base;
a piston non-rotatably connected to one of the legs;
a first clutch plate and a second clutch connected to each other; and
an intermediate clutch plate disposed between the first and second clutch plates and non-rotatably connected to the other of the legs.

14. The lock-up clutch according to claim 13, wherein the piston is connected to the one of the legs radially inside of the first and second clutch plates.

15. The lock-up clutch according to claim 14, wherein the piston is connected to the one of the legs radially inside of the intermediate clutch plate.

16. The lock-up clutch according to claim 13, wherein the intermediate clutch plate is connected to the other of the legs radially inside of the first and second clutch plates.

17. The lock-up clutch according to claim 13, wherein the intermediate clutch plate is connected to the other of the legs at a radial inner end thereof.

18. The lock-up clutch according to claim 13, wherein the legs are radially offset relative to each other.

19. The lock-up clutch according to claim 13, wherein the legs extend circumferentially from the base, the legs being arranged on a same circumferential side of the base.

20. The lock-up clutch according to claim 13, wherein the clutch plate is supported by the leaf spring.
